(19) United States
(12) Patent Application Publication
(10) Pub. No.: US 2004/0051763 A1
(43) Pub. Date: Mar. 18, 2004

(54) Piezoelectric thin film element, actuator, ink-jet head and ink-jet recording apparatus therefor

(76) Inventors: Shogo Matsubara, Kasuga-shi (JP); Shintaro Hara, Fukuoka-shi (JP); Takeshi Kamada, Nara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/659,329

(22) Filed: Sep. 11, 2003

(30) Foreign Application Priority Data
Sep. 13, 2002 (JP) P.2002-268510

(51) Int. Cl. B41J 2/045

(52) U.S. Cl. 347/68

(57) ABSTRACT

A method and apparatus for a piezo-electric thin film element includes a substrate, a first electrode formed on the substrate, a dielectric thin film formed on the first electrode, and a second electrode formed on the dielectric film. The dielectric film includes a piezo-electric layer exhibiting piezo-electric characteristics, and a stress-reducing layer for lowering the stress between the substrate and the dielectric film.

### BACKGROUND OF THE INVENTION

The present invention relates to a piezoelectric thin film element for use in a piezoelectric element, an infrared-ray detecting element of pyro-electricity type, an un-volatilizing memory, an electro-optics effect element, and so on. In particular, it relates to an actuator using a piezoelectric effect of dielectric material with a piezo-electric nature, an ink-jet head therefor, and an ink-jet apparatus with the head.

In electronics fields, there are many applied technologies using dielectric materials, for example piezoelectric elements, infrared sensors, optical modulation elements, memory elements, and so on.

According to developments of micromachine processing technology and demands for compactness and light weight of various apparatuses, various thin film devices have been in practical use.

I. Kanno et. al: Applied Physics Let. 70(1997) P1378-1380 provides an example of a piezoelectric thin film element to create these thin film elements. FIG. 12 shows a cross-sectional view of the piezoelectric thin film element 90. The piezoelectric thin film element 90 includes a MgO substrate 91, a Pt lower electrode 92 as a first electrode, a PZT piezoelectric thin film 93 and a Pt upper electrode 94 as a second electrode. The Pt lower electrode 92, the PZT piezoelectric thin film 93 and the Pt upper electrode 94 are formed on the MgO substrate 41 in order.

In a forming process of the piezoelectric thin film 90, the piezoelectric thin film 90 requires a crystallization treatment at 500 to 700 degrees. Because of this, in a process of cooling the piezoelectric thin film 90 down to room temperature, some compression or depression stresses in the PZT piezoelectric thin film 93 occur due to the difference between the heat expansion coefficients of the PZT piezoelectric thin film 93 and the substrate 91 supporting the PZT piezoelectric thin film 93.

Because of this, the mechanical intensity of the PZT piezoelectric thin film 93 falls, and there is a problem of occurrence of some cracks and an insulated destruction in the PZT piezoelectric thin film 93, successively, during operation of the PZT piezoelectric thin film 93.

The present invention was devised under these circumstances. An object of the invention is to reduce an internal stress of the piezoelectric thin film.

### SUMMARY OF THE INVENTION

In order to achieve the aforementioned object, according to the invention, the piezoelectric thin film element includes a substrate, a first electrode formed on the substrate, a dielectric thin film formed on the first electrode, and a second electrode formed on the dielectric thin film. The piezoelectric thin film includes a piezoelectric layer (i.e., a material layer that exhibits piezoelectric characteristics) and a stress reduction layer having smaller young's modulus than the piezoelectric layer. The stress reduction layer is isolated from the first and second electrodes.

Due to this structure, the internal stress of the dielectric thin film can be reduced, and the reduction in the mechanical intensity of the dielectric thin film can be prevented. Also, the occurrence of cracks and the dielectric breakdown of the dielectric thin film can be suppressed.

### BRIEF DESCRIPTION OF THE DRAWINGS

FIG. 1 is a schematic perspective view of an ink-jet printer using a piezoelectric thin film of the first embodiment.

FIG. 2 is a sectional perspective view of an ink-jet head of the ink-jet printer in FIG. 1.

FIG. 3 is a sectional perspective view of primary portion of the ink-jet head in FIG. 2.

FIG. 4 is a sectional view of an actuator portion of the ink-jet head in FIG. 2.

FIG. 5 is a sectional view of a piezoelectric thin film of the first embodiment.

FIG. 6 is a sectional view of other piezoelectric thin film of the first embodiment.

FIG. 7 is a sectional view of a piezoelectric thin film of the second embodiment.

FIG. 8 is a graph showing a relationship between the composition of a Pb(Z_{ry}+Ti_{1-y})O₃ thin film and the lattice constant of Pb(Z_{ry}+Ti_{1-y})O₃ thin film under room temperature.

FIG. 9 is a graph showing a relationship in condition y<0.6 between the temperature of a Pb(Z_{ry}+Ti_{1-y})O₃ thin film and the lattice constant of a Pb(Z_{ry}+Ti_{1-y})O₃ thin film under room temperature.

FIG. 10 is a graph showing a relationship between the composition of a Pb(Z_{ry}+Ti_{1-y})O₃ thin film and the heat expansion coefficient of a Pb(Z_{ry}+Ti_{1-y})O₃ thin film.

FIG. 11 is a sectional view of another piezoelectric thin film of the third and forth embodiments.

FIG. 12 is a sectional view of a piezoelectric thin film of the related art.

FIG. 13 is a sectional view of a step in manufacturing the piezo-electric thin film element of the first embodiment.

FIG. 14 is a sectional view of a step in manufacturing the piezo-electric thin film element of the first embodiment.

FIG. 15 is a sectional view of a step in manufacturing the piezo-electric thin film element of the first embodiment.

FIG. 16 is a sectional view of a step in manufacturing the piezo-electric thin film element of the first embodiment.

FIG. 17 is a sectional view of a step in manufacturing the piezo-electric thin film element of the first embodiment.

FIG. 18 is a sectional view of a step in manufacturing the piezo-electric thin film element of the first embodiment.

### DETAILED DESCRIPTION OF THE INVENTION

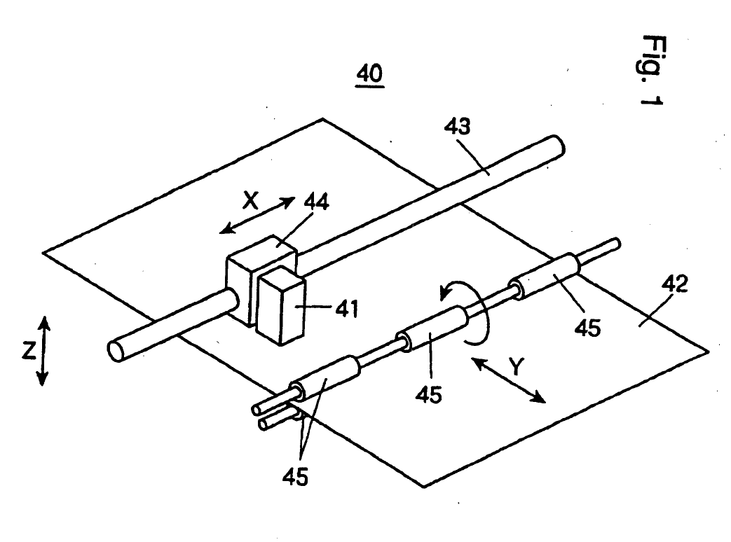

Now, preferred embodiments of the invention will be described using FIGS. 1 through 11. In addition, the same number is given to the same component, and any overlapping explanation is omitted.

(First Embodiment)

FIG. 1 shows an ink-jet printer using a piezoelectric thin film of the first embodiment.

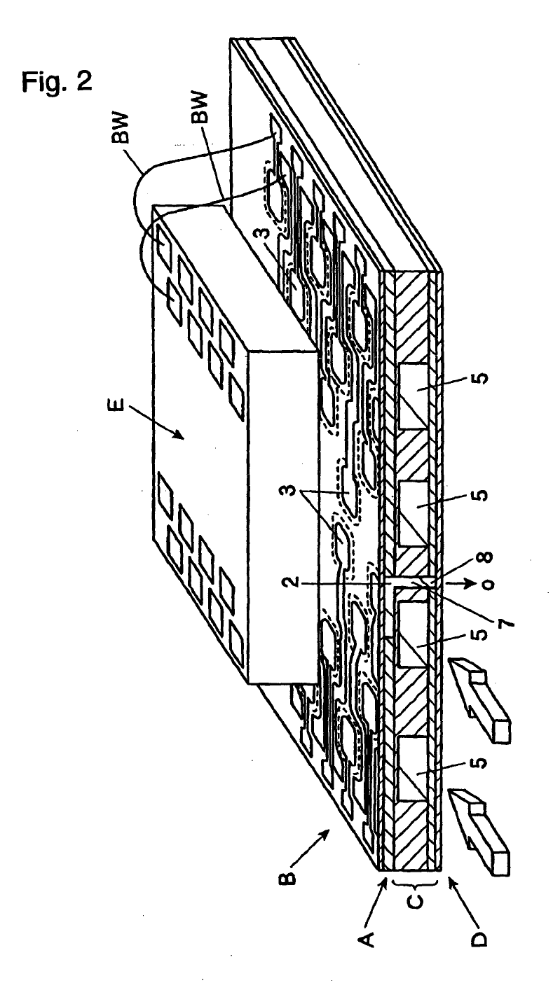

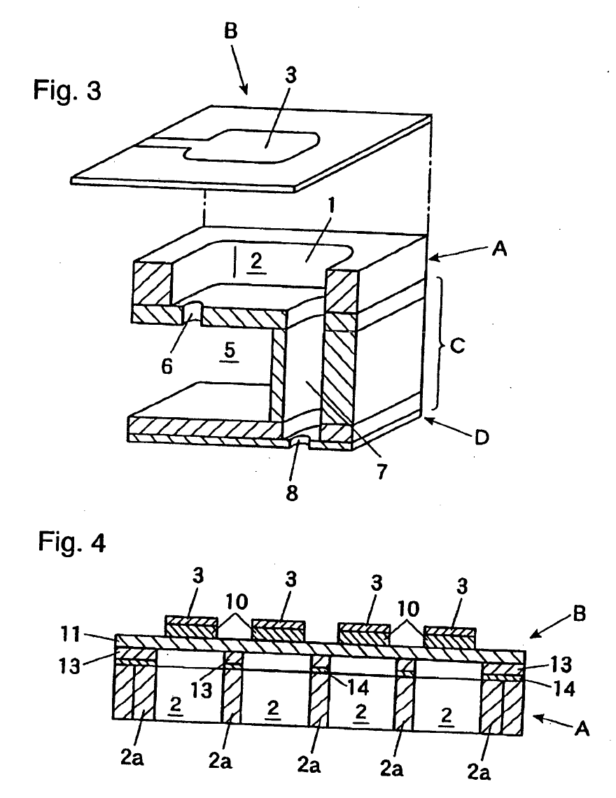

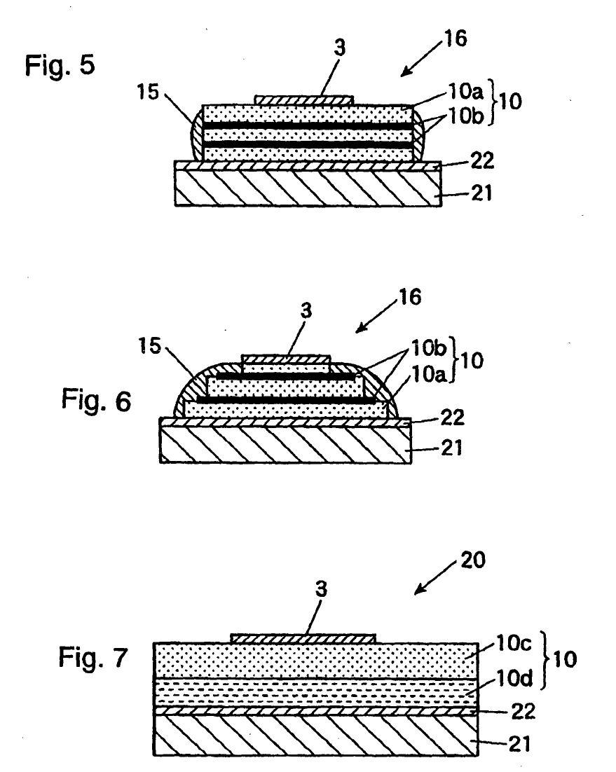

FIG. 2 shows an ink-jet head of the ink-jet printer in FIG. 1. FIG. 3 shows a primary portion of the ink-jet head in FIG. 2. FIG. 4 shows an actuator portion of the ink-jet head in FIG. 2 FIG. 5 shows a piezoelectric thin film of the first embodiment. FIG. 6 shows another piezoelectric thin film of the first embodiment.

An ink-jet recording apparatus 40 shown in FIG. 1 carries an ink-jet head 41 to record utilizing a piezoelectric effect of a piezoelectric thin film element. The ink-jet printer 40 records on a recording medium 42 by ejecting some ink-droplets from the ink-jet head 41 toward the recording medium 42.

The ink-jet head 41 is carried on a carriage 44. The carriage 44 is located on a carriage axis 43 set along the main scanning direction X. The ink-jet head 41 reciprocates along the main-scanning direction X in accordance with the carriage 44 reciprocating along the carriage axis 43.

The ink-jet recording apparatus 40 includes a plurality of rollers 45 to make a recording medium 42 move in the sub-scanning direction Y orthogonal to the width direction of the ink-jet head 41(that is, the main-scanning direction X).

FIG. 2 shows a view of the whole structure of the ink-jet head 41, and FIG. 3 shows a view of a primary portion of the ink-jet head 41. In FIG. 2 and FIG. 3, the ink-jet head 41 comprises a pressure chamber part A, an actuator portion B, a ink passage portion C and a nozzle plate D.

The pressure chamber part A has a plurality of opening portions 1. The opening portions 1 are covered with the actuator portion B and the ink passage portion C on both edge surfaces of the pressure chamber A. The spaces of the opening portions 1 closed by portions B and C function as pressure chambers 2.

The actuator portion B includes a plurality of second electrodes 3 located on the pressure chambers 2. The second electrodes 3 are separated from each other. As shown in FIG. 2, the sets of pressure chambers 2 and second electrodes 3 are arranged alternately.

The ink passage portion C includes a common ink passage 5 connected with the plurality of pressure chambers 2, an inlet port 6 connected between chambers 2 and passage 5, and an ink passage 7 allowing the ink to flow to nozzle plate D. The plurality of pressure chambers 2 are arranged along the ink flowing direction YY in the common ink passage 5.

The nozzle plate D has a plurality of nozzles 8 communicating with the ink passage 7. As shown in FIG. 2, IC chip E connects to the second electrodes 3 via bonding wires BW, and supplies the electricity for the second electrodes.

Next, the structure of the actuator portion B is described in detail based on FIG. 4. FIG. 4 shows a sectional view orthogonal to the direction YY of an actuator portion of the ink-jet head 4 in FIG. 2. Referentially, FIG. 4 shows the pressure chamber part A having four pressure chambers 2, and shows the actuator portion B corresponding to the pressure chamber part A. The actuator part B, includes a dielectric thin film 10 located under the second electrode 3, and includes a vibration plate 11 for carrying a displacement and vibration due to the piezo-electric characteristics of the dielectric thin film. The vibration plate 11 also forms a first electrode.

The vibration plate 11 is formed from a conductive material. The vibration plate 11 is common to each pressure chamber 2. Furthermore, the actuator portion B includes a plurality of longitudinal walls 13 located on a partition wall 2a disposed between two adjacent pressure chambers 2. The pressure chamber part A and the actuator portion B are united with adhesive 14. Because the longitudinal walls 13 are located between the partition wall 2a and the vibration plate 11, each of the partition walls 2a is separated from the vibration plate 11. The longitudinal walls 13 prevent the vibration plate 11 from attaching to adhesive 14 even if the adhesive 14 overflows from the partition wall 2a at the time of adhesion.

A piezo-electric thin film element is made up of the dielectric thin film 10, the second electrode 3 and the vibration plate 11.

Though in this embodiment the vibration plate 11 also serves as (forms) the first electrode, the vibration plate and the first electrode may be disposed separately. A case like this is shown in FIGS. 5 to 7.

The second electrodes 3 are formed with a metal whose main ingredient is the Platinum Group precious metal, such as, for example, Pt, Ir, Ru, Os and Pd, an alloy of the metals, or the oxide of the metal or the alloy. The vibration plate 11 is formed with a metal, such as for example, Pt, Cr, Cu, Mo and Ta, an alloy containing at least one of the metals, or the oxide of the metal or the alloy.

In FIG. 5, a piezo-electric thin film element includes a substrate 21 of silicon, a first electrode 22 of Pt formed on the substrate 21, a dielectric thin film element 10 formed on the first electrode 22, and the second electrode 3 of Pt formed on the dielectric thin film element 10. The dielectric thin film element 10 includes a piezo-electric layer 10a formed of a PZT thin film with a composition of Pb(Zr_{0.52}Ti_{0.48})0₃, and includes a stress reducing layer 10b formed of a material having a smaller young's modulus than that of the piezo-electric layer 10a. The stress-reducing layer 10b includes two layers with a total thickness of 0.03 to 0.3 μm and is isolated from the first electrode 22 and the second electrode 3.

An insulation material 15 covers the side wall of the dielectric thin film 10 to prevent any short-circuiting between the two stress-reducing layers. In addition, the substrate 21 can be made from stainless steel, glass or MgO single crystal.

Also, the piezo-electric layer 10a can be made from an oxide solid-solution having a perovskite structure expressed by chemical formula “ABO₃”, containing at least one element selected from Pb, Ba, Nb, La, Li, Sr, Bi, Na and K as “A”, and at least one element selected from Cd, Fe, Ti, Ta, Mg, Mo, Ni, Nb, Zr, Zn, W and Yb as “B”. Preferably, the piezo-electric layer 10a can be made from one of the oxide solid-solutions of perovskite structure containing “Pb” as “A”. Furthermore, Pb₁₊ₓ(Z_{ry}+Ti_{1-y})O₃ (x=0˜0.5) is the most proper material to be used as the piezo-electric layer 10a.

In addition, Pb(Zr,Ti)O₃, (Pb,La) (Zr,Ti)O₃, Pb(Mg_{1/3}, Nb_{2/3})O₃, Pb(Mg_{1/2}, W_{1/2})O₃, Pb(Zn_{1/3}, Nb_{2/3})O₃, Pb(Cd_{1/2}, W_{1/2})O₃, Pb(Fe_{2/3}, W_{1/3})O₃, Pb(Yb_{1/2}, Nb_{1/2})O₃, PbTiO₃ and solid-solutions of these materials, or PbZrO3 and solid-solutions of these materials are known as the oxide solid solutions of perovskite structure containing “Pb” as “A”.

The stress reducing layer 10b can be made from a metal or an oxide thereof whose main ingredient is a precious metal of Pt system having a spread nature like Pt, Ir, Ru, Os, Pd etc.

Next, a process of manufacturing the piezo-electric thin film element 16 will be described using FIGS. 13 through 18.

First, as shown in FIG. 13, a first Pt film 10ba with a thickness of 0.2 μm is formed by sputtering on the surface of the substrate 21 heated to about 600 to 650 degrees, then, as shown in FIG. 14, a first PZT film 10aa with a thickness of 1 μm is formed by sputtering on the surface of the first Pt film 10ba. After that, as shown in FIG. 15, a second Pt film 10bb, a second PZT film 10ab, a third Pt film 10bc and a third PZT film 10ac are formed, in order, by repeating the above procedure two times. At last, a fourth Pt film 10bd with a thickness of 0.2 μm is formed on the third PZT film 10ac. The sputtering is accomplished by RF magnetron sputtering equipment. Pt films are formed in conditions such that the atmosphere is Ar gas of about 0.3 Pa and the temperature of the substrate 21 is around 650 degrees. PZT films are formed in condition that the atmosphere is Ar mixed gas with a partial pressure 10% of Oxygen of about 0.3 Pa, and the temperature of the substrate 21 is around 620 degrees.

The first Pt film 1 10ba formed on the substrate 21 forms the first electrode 22. The first, second and third PZT films 10aa, 10ab, and 10ac form the piezoelectric layer 10a. The second and third Pt films 10bb and 10bc located between PZT films 10aa, 10ab and 10ac works form the stress-reducing layer 10b.

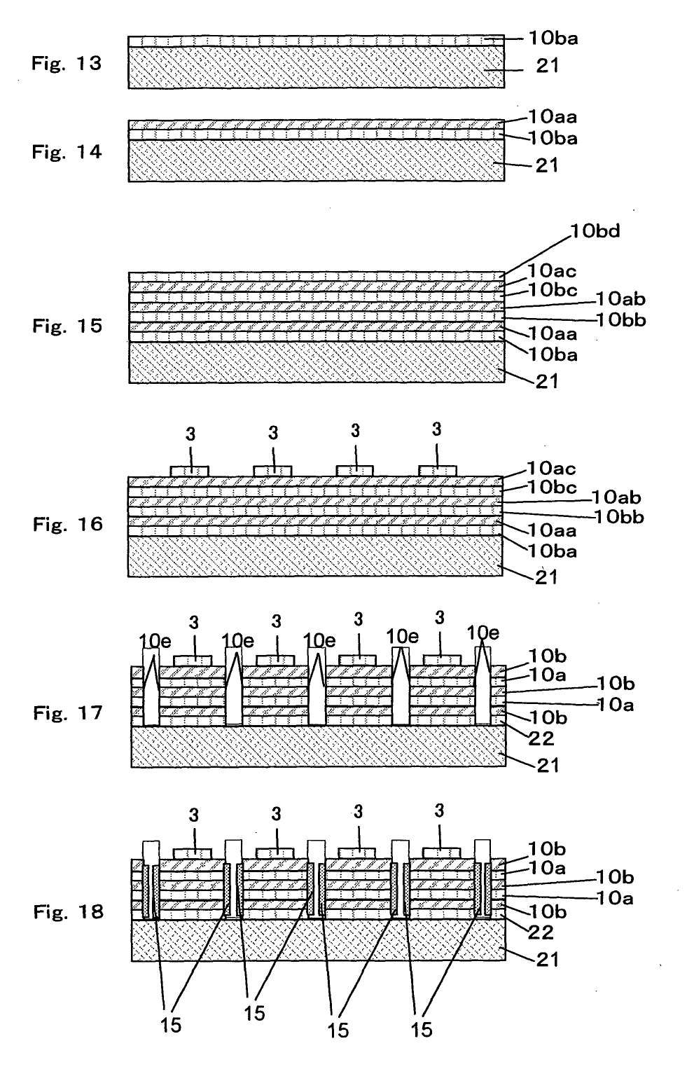

Subsequently, as shown in FIG. 16, the fourth Pt film 10bd located on the top of the dielectric thin film element 10 is etched by photolithography. After that, the fourth Pt film 10bd is divided into a plurality of electrodes which are separated, respectively, and those electrodes form the second electrodes 3.

Furthermore, as shown in FIGS. 6 and 17, the piezo-electric layers 10a and the stress-reducing layers 10b are separated by dry or wet etching, due to the separation, side walls 10e of the piezo-electric layers 10a and the stress-reducing layers 10b are formed. Insulation material 15 is formed on the side walls 10e. The insulation material 15 prevents short-circuiting between the stress-reducing layers 10b. As shown in FIG. 18, the insulation material 15 can be made from inorganic material such as SiO₂ and Si₃N₄, or organic resin such as resist and polyimide. The insulation material 15 can be formed by applying a coat of insulation material or using one of the well-known semiconductor manufacturing methods.

Additionally, as shown in FIG. 6, an electric short circuit may be prevented by changing the area of the stress-reducing layers 10b which sandwich the piezo-electric layers 10a as insulated layers. In this case, it is desirable so that the areas of the stress-reducing layers 10b may become smaller in order as these are away from the substrate 21.

In the above-described embodiment, the piezo-electric thin film 16 can lessen the internal stresses due to the stress-reducing layer 10b if the internal stresses originate from the difference between heat expansion coefficient of the PZT piezoelectric thin film 16 and the substrate 21 during a process of cooling the substrate 21 down to room temperature, and a drop in the mechanical intensity of the dielectric thin film can be prevented. Also, the occurrence of cracks and the dielectric breakdown of the dielectric thin film can be suppressed.

(Second Embodiment)

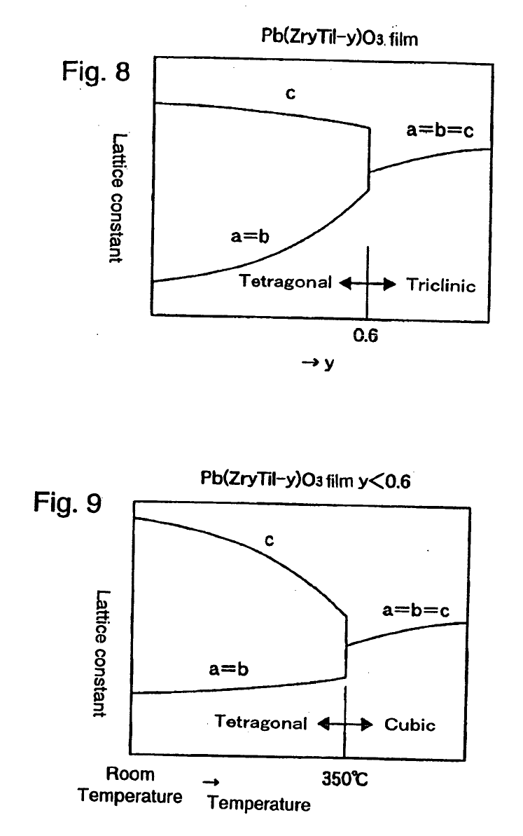

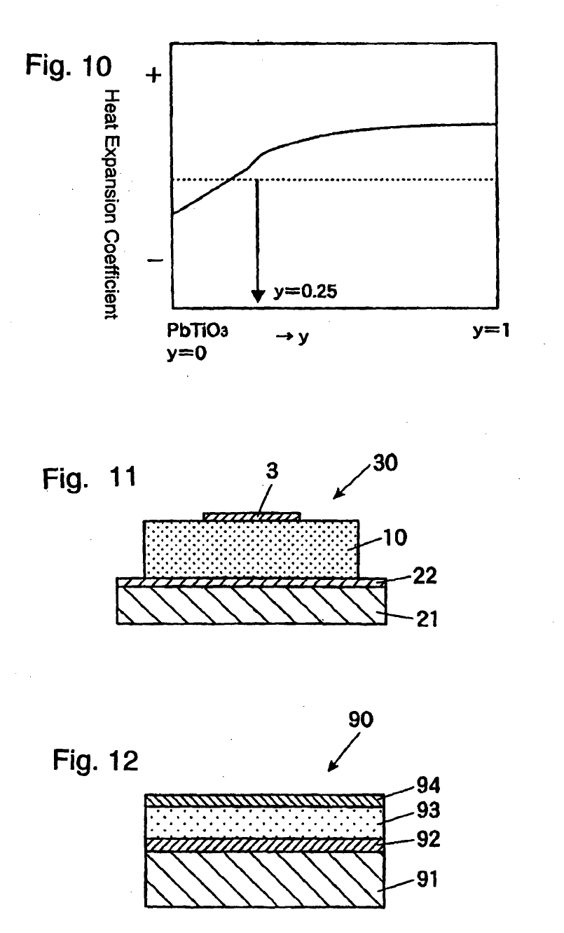

FIG. 7 shows a sectional view of a piezoelectric thin film of the second embodiment. FIG. 8 shows a graph of a relationship between the composition of a Pb(Z_{ry}+Ti_{1-y})O₃ thin film and the lattice constant of a Pb(Z_{ry}+Ti_{1-y)O}₃ thin film under room temperature. FIG. 9 shows a graph of a relationship in condition y<0.6 between the temperature of a Pb(Z_{ry}+Ti_{1-y})O₃ thin film and the lattice constant of a Pb(Z_{ry}+Ti_{1-y})O₃ thin film under room temperature. FIG. 10 shows a graph showing a relationship between the composition of a Pb(Z_{ry}+Ti_{1-y})O₃ thin film and the heat expansion coefficient of a Pb(Z_{ry}+Ti_{1-y})O₃ thin film.

A piezo-electric thin film element 20 in FIG. 7 comprises a substrate 21, a first electrode 22 formed on the substrate 21, a dielectric thin film 10 formed on the first electrode 22 and a second electrode 3 formed on the dielectric thin film 10. The first and second electrodes can be made from metal material such as Pt, Ir, Ru, Os and Pd, a alloy of the metals, or the oxide of the metal or the alloy.

The dielectric thin film element 10 includes a piezo-electric layer 10c formed with a PZT thin film whose composition is Pb(Zr_{0.52}Ti_{0.48})O₃ and a stress-reducing layer 10d formed of a material having a different heat expansion coefficient from that of the piezo-electric layer 10c. The stress-reducing layer 10d is formed between the piezo-electric layer 10c and the first electrode 22 with a total thickness 0.03 to 0.3 μm. In addition, the total thickness of the stress-reducing layer 10d may be beyond the aforesaid range more or less, and the stress-reducing layer 10d should just consist of at least one or more layers.

Also, the piezo-electric layer 10c and the stress-reducing layer 10d can be made from an oxide solid-solution of a perovskite structure expressed by chemical formula “ABO₃”, containing at least an element selected from Pb, Ba, Nb, La, Li, Sr, Bi, Na and K as “A”, and at least an element selected from Cd, Fe, Ti, Ta, Mg, Mo, Ni, Nb, Zr, Zn, W and Yb as “B”. Preferably, the piezo-electric layer 10a can be made from one of the oxide solid-solutions of perovskite structure containing “Pb” as “A”. Furthermore, Pb₁₊ₓ(Z_{ry}+Ti_{1-y})O₃ (x=0˜0.5) is the most proper material for the piezoelectric layer 10a. In addition, Pb(Zr,Ti)O₃, (Pb,La) (Zr,Ti)O₃, Pb(Mg_{1/3}, Nb_{2/3})O₃, Pb (Mg_{1/2}, W_{1/2})O₃, Pb(Zn_{1/3}, Nb_{2/3})O₃, Pb(Cd_{1/2}, W_{1/2})O₃, Pb(Fe_{2/3}, W_{1/3})O₃, Pb(Yb_{1/2}, Nb_{1/2})O₃, PbTiO₃ and solid-solutions of these materials, or PbZrO₃ and solid-solutions of these materials are known as the oxide solid solutions of a perovskite structure containing “Pb” as “A”.

When the piezo-electric layer 10c and the stress-reducing layer 10d are formed by PZT films such as Pb₁₊ₓ(Z_{ry}+Ti_{1-y}) O₃ (x=0˜0.5), the lattice constant of the PZT films change with composition, as shown in FIG. 8, and with temperature, as shown in FIG. 9. Because of these features, the heat expansion coefficient of the PZT films with random orientation polarization changes continuously with the composition as shown in FIG. 10, and the polarity of the PZT film changes near y=0.25. Utilizing this feature, the heat expansion coefficient of the piezo-electric layer 10c can be changed with the heat expansion coefficient of the stress-reducing layer 10d by setting the “y” of the piezo-electric layer 10c from 0.5 to 0.6 and setting the “y” of the stress reducing layer 10d from 0.1 to 0.3.

Next, a manufacturing method of the piezo-electric thin film 20 will be described.

First, Pt film as the first electrode 22 is formed by sputtering on the surface of the substrate 21 heated to about 600 degrees. Then, a PZT film as the stress-reducing layer 10d is formed by sputtering on the surface of the first electrode 22. After that, a PZT film as the piezo-electric layer 10c is formed by sputtering on the surface of layer 10d. At last, Pt film as the second electrode 3 is formed on the piezo-electric layer 10c.

The sputtering is conducted by RF magnetron sputtering equipment. Pt films are formed in a condition such that the atmosphere is Ar gas of about 0.3 Pa and the temperature of the substrate 21 is around 650 degrees. PZT films are formed in conditions such that the atmosphere is Ar mixed gas with partial pressure 10% of Oxygen of about 0.3 Pa and the temperature of the substrate 21 is around 620 degrees.

In the above-described embodiment, the piezo-electric thin film 20 can lessen the internal stresses in view of the stress-reducing layer 10d if the internal stresses in the dielectric thin film 10 originate from the difference between the heat expansion coefficient of the dielectric thin film 10 and the substrate 21 in a process of cooling the substrate 21 down to room temperature, and a reduction in the mechanical intensity of the dielectric thin film 10 can be prevented. Also, the occurrence of cracks and the dielectric breakdown of the dielectric thin film 10 can be suppressed.

(Third Embodiment)

FIG. 11 shows a sectional view of a piezoelectric thin film of a third and embodiment. A piezo-electric thin film element 30 in FIG. 11 comprises a silicon substrate 21, Pt ilm as a first electrode 22 formed on the substrate 21, a dielectric thin film 10 formed on the first lectrode 22, and a Pt film as a second electrode 3 formed on the dielectric thin film 10.

The dielectric thin film 10 is formed of a composition such as Pb₁₊ₓ(Z_{ry}+Ti_{1-y})O₃ (X=0˜0.5). When the heat expansion coefficient of the substrate 21 is from 20×10⁻⁷ (K−1) to 40×10⁻⁷ (K⁻¹), the “y” of The dielectric thin film 10 is controlled from 0.4 to 0.5. When the heat expansion coefficient of the substrate 21 is from 60×10⁻⁷ (K−¹) to 150×10⁻⁷(K⁻¹), the “y” of the dielectric thin film 10 is controlled from 0.5 to 0.7.

That is, when the heat expansion coefficient of the substrate 21 is from 20×10⁻⁷ (K⁻¹) to 40×10⁻⁷ (K⁻¹), a tensile stress is applied to the dielectric thin film 10. Then if the “y” of the dielectric thin film 10 is controlled from 0.4 to 0.5, the anisotropy of the dielectric thin film 10 (c/a in figs.) becomes larger in the crystal structure as the temperature of the substrate 21 lowers from high temperature to room temperature. Therefore, the tensile stress applied to the dielectric thin film 10 is relaxed as the anisotropy of the dielectric thin film 10 changes in the direction to relax the tensile stress when the tensile stress is applied from the substrate 21.

On the other hand, a compressive stress is applied to the dielectric thin film 10 when the heat expansion coefficient of the substrate 21 is from 60×10⁻⁷ (K⁻⁷) to 150×10⁻⁷ (K⁻¹). In this case, the “y” of the dielectric thin film 10 can be controlled from 0.5 to 0.7, at which the piezo-electric characteristics of the dielectric thin film 10 can have some higher values because the dielectric thin film 10 does not have to be coordinated with its internal stress.

Next, a manufacturing method of the piezo-electric thin film 30 will be described. First, a Pt film as the first electrode 22 is formed by sputtering on the surface of the substrate 21 heated about 600 degrees. Then, a PZT film made of Pb₁₊ₓ(Zry+Ti_{1-y})O₃ (X=0˜0.5) for the dielectric thin film 10 is formed by sputtering on the surface of the first electrode 22 while controlling the composition of “y” of the dielectric thin film 10 in accordance with the heat expansion coefficient of the substrate 21. At last, a Pt film as the second electrode 3 is formed on the dielectric thin film 10.

The sputtering is conducted by the RF magnetron sputtering equipment. Pt films are formed in conditions such that the atmosphere is Ar gas of about 0.3 Pa and the temperature of the substrate 21 is around 650 degrees. PZT films are formed in conditions such that the atmosphere is Ar mixed gas with partial pressure 10% of Oxygen of about 0.3 Pa and the temperature of the substrate 21 is around 620 degrees. The way to control the composition of “y” of the dielectric thin film 10 is to change the composition of Zr or Ti in the sputtering target in accordance with the heat expansion coefficient of the substrate 21.

In the above-described piezo-electric thin film 30, the internal stress of the dielectric thin film 10, which originates during a process of cooling the substrate 21 down to room temperature, can be relaxed by selecting the composition of the dielectric thin film 10 in accordance with the heat expansion coefficient of the substrate 21. Because of this, a reduction in the mechanical intensity of the dielectric thin film 10 can be prevented. Also, the occurrence of cracks and the dielectric breakdown of the dielectric thin film 10 can be suppressed.

(Fourth Embodiment)

Explanations about the piezo-electric thin film element 30 are omitted in this embodiment because the piezo-electric thin film element 30 is the same as that of the third embodiment.

The dielectric thin film 10 is a poly crystal PZT film(randomly oriented) made from the oxide solid solutions of perovskite structure containing a tetragonal structure, such as Pb₁₊ₓ(Z_{ry}+Ti_{1-y})O₃ (x=0˜0.5).

The heat expansion coefficient of the substrate 21 is defined as “αs”. The heat expansion coefficient of the dielectric thin film 10 is defined as “αf”, and the ratio αs/αf is set to “α”. When this ratio is 0.3<α<0.7, the c-axis oriented rate of the dielectric thin film 10 is around 10% to 40%, and when it is 1<α<2.5, the c-axis oriented rate of the dielectric thin film 10 is around 60% to 100%.

The “αf” changes greatly with a material composition around 30 to 110×10⁻⁷ (K⁻¹). For example, when the dielectric thin film 10 is made from Pb(Zr_{0.52}, Ti_{0.48})O3, the “αf” is about 80×10⁻⁷ (K⁻¹). When the dielectric thin film 10 is made from Pb(Mg_{1/3}, Nb_{2/3})O₃, the “αf” is about 40×10⁻⁷ (K⁻¹). When the dielectric thin film 10 is made from Pb(Zr_{1/3}, Nb_{2/3})O₃, the “αf” is about 50×10⁻⁷ (K⁻¹).

The dielectric thin film 10 has the particular feature that the heat expansion coefficient changes with the direction of the axis. That is, the heat expansion coefficient in c-axis is a negative value, and the heat expansion coefficient in a-axis is a positive value. Utilizing this feature, the heat expansion coefficient of the oriented dielectric thin film can be controlled.

When the “αf” is larger than the “αs”, that is, 0.3<α<0.7, the c-axis oriented rate of the dielectric thin film 10 is controlled around 10% to 40% or the c-axis oriented rate of the dielectric thin film 10 is made larger than the a-axis oriented rate. Because of this, the “αf” is made small; and the internal stress of the dielectric thin film 10 can be relaxed.

On the other hand, when the “αf” is smaller than the “αs”, that is, 1<α<2.5, the c-axis oriented rate of the dielectric thin film 10 is controlled around 60% to 100% or the c-axis oriented rate of the dielectric thin film 10 is made smaller than the a-axis oriented rate. Because of this, the “αf” is made large; and the internal stress of the dielectric thin film 10 can be relaxed.

Specifically, when the “αs”l is around 20˜40×10⁻⁷ (K⁻¹), considering the aforementioned “αf”, the “αs” is smaller than the “αf”. Therefore, the c-axis oriented rate of the dielectric thin film 10 is controlled around 10% to 40%, then the “αf” is made small, and then the internal stress of the dielectric thin film 10 can be relaxed.

Further, when the “αs” is around 60-100×10⁻⁷ (K⁻¹), considering the aforementioned “αf”, the “αs” is larger than the “αf”. Therefore, the c-axis oriented rate of the dielectric thin film 10 is controlled around 60% to 100%, then the “αf” is made large, and then the internal stress of the dielectric thin film 10 can be relaxed.

Next, a procedure for manufacturing the piezo-electric thin film element 30 will be described using FIG. 11. In FIG. 11, a Pt film (the first electrode 22) with a thickness of 0.2 μm and a PZT film (the dielectric thin film 10) with a thickness of 1 μm are formed in order on the surface of (001)MgO single crystal substrate(the substrate 21). Finally, a Pt film (the second electrode 3) with a thickness of 0.2 μm is formed on the PZT film. All kinds of films are formed by sputtering, which is conducted by the RF magnetron sputtering equipment. In addition, the first electrode 22 and the second electrode 3 can be made from metal material such as, Ir, Ru, Os and Pd, or an alloy of the metals.

The structures of crystal of the Pt film or the PZT film change with sputtering conditions. Pt film is formed in conditions such that the atmosphere is Ar gas of about 0.3 Pa, and the temperature of the substrate is around 650 degrees, and PZT film is formed in condition such that the atmosphere is Ar mixed gas with partial pressure 10% of Oxygen of about 0.3 Pa and the temperature of the substrate 21 is around 620 degrees. Consequently, the Pt film and the PZT film carry out epitaxial growth in the (001) direction on a single crystal substrate of (001) MgO.

When PZT film includes a tetragonal structure in its crystal structure, the (001) direction in PZT film is divided into a c-axis and a-axis, and c-domains and a-domains are produced in PZT film. When this PZT film is analyzed by the powder X-ray diffraction method, the diffraction intensity Ic from c-domains and the diffraction intensity 1a from a-domain will be obtained. The c-axis oriented rate is defined as Ic/(Ic+1a)×100(%).

On the other hand, The c-axis oriented nature of PZT film is controllable by adjusting the cooling speed of the substrate temperature after its deposition. That is, in the cooling process of substrate 21 after deposition of PZT film, if the substrate 21 is cooled slowly from 620° C. to 400° C., for example, at the cooling speed of 1° C. or less a minute, then the c-axis oriented rate of the PZT film will become 10-40%. On the other hand, if the substrate 21 is cooled rapidly from 620° to 400° C., for example, at the cooling speed of 20° C. or more a minute, then the c-axis oriented rate of the PZT film will become 60-100%.

Then, the cooling speed of the substrate after the deposition of the PZT film is controlled in order to make it a desired c-axis oriented rate of the PZT film according to the relation between the heat expansion coefficient of a substrate 21 and the heat expansion coefficient of the dielectric thin film 10.

The reason why the c-axis oriented rate is controllable by adjusting the cooling speed of the substrate 21 is not clear. However, the following can be considered. PZT film having the tetragonal structure in the crystal growth starts the phase transition to the cubic structure at the Curie point. Then, cooling the substrate 21 slowly, the c axis of each crystal grain is turned at random to the thickness direction and the in-plane direction so that internal stress of the PZT film is relaxed. Consequently, the c-axis oriented nature of PZT film is reduced.

In the above-described piezo-electric thin film 30, the heat expansion coefficient of the dielectric thin film 10 can be controlled by adjusting the c-axis oriented rate of the dielectric thin film 10 corresponding to the heat expansion coefficient of the substrate 21. Therefore, when the substrate 21 heated in a thin film forming process is cooled to room temperature, the internal stress of the dielectric thin film 10 can be relaxed. Because of this, the occurrence of cracks and the dielectric breakdown of the dielectric thin film 10 can be suppressed.

In the above-described embodiments 1-4, although it is explained that the dielectric thin film elements are applied to an ink ejecting actuator for an ink-jet recording apparatus as examples, the dielectric thin film elements can be applied to various other devices, for example, such as a temperature sensor using the pyro-electricity nature, a light modulation device using the electro-optics effect, an optical actuator using the optical elastic effect, and a SAW device.

In addition, by using the aforementioned piezo-electric thin film elements for an actuator, it is possible for the actuator to perform a stable displacement operation. Also, by using the aforementioned actuator for an ink-jet head, it is possible for the ink-jet head to perform a stable ink-ejecting operation. Furthermore, by using the aforementioned ink-jet head for an ink-jet recording apparatus, it is possible for the ink-jet head to perform high-quality printing by the stable ink-ejecting operation of the ink-jet head. Additionally, the structures and the forming methods recited in embodiments 1-4 can be combinable with each other suitably.

What is claimed is:

1. A piezo-electric film element comprising:
a substrate;
a first electrode formed on said substrate;
a dielectric film formed on said first electrode, said dielectric film including a piezo-electric layer and including a stress-reducing layer for reducing a stress between said substrate and said dielectric film; and
a second electrode formed on said dielectric film.

2. The piezo-electric film element of claim 1, wherein said stress-reducing layer is electrically insulated from said first electrode and said second electrode, and a Young's modulus of said stress-reducing layer is smaller than a Young's modulus of said piezo-electric layer.

3. The piezo-electric film element of claim 1, wherein said piezo-electric layer comprises an oxide solid-solution having a perovskite structure expressed by a chemical formula ABO₃, including at least one A element selected from a group consisting of Pb, Ba, Nb, La, Li, Sr, Bi, Na and K, and including at least one B element selected from a group consisting of Cd, Fe, Ti, Ta, Mg, Mo, Ni, Nb, Zr, Zn, W and Yb.

4. The piezo-electric film element of claim 1, wherein said piezo-electric layer comprises a PZT film expressed by a formula: Pb₁₊ₓ(Zr_{y}+Ti_{1-y})O₃ (x=0*0.5).

5. The piezo-electric film element of claim 1, wherein said stress-reducing layer comprises a metal material or an oxide of said metal material, said metal material comprising at least one of the platinum group of precious metals.

6. The piezo-electric film element of claim 1, wherein a heat expansion coefficient of said stress-reducing layer is different than a heat expansion coefficient of said piezoelectric layer.

7. The piezo-electric film element of claim 6, wherein each of said piezo-electric layer and said stress depressing layer comprises an oxide solid-solution having a perovskite structure expressed by a chemical formula ABO₃, including at least one A element selected from a group consisting of Pb, Ba, Nb, La, Li, Sr, Bi, Na and K, and including at least one B element selected from a group consisting of Cd, Fe, Ti, Ta, Mg, Mo, Ni, Nb, Zr, Zn, W and Yb.

8. The piezo-electric film element of claim 7, wherein said piezo-electric layer comprises a PZT film expressed by a formula: Pb₁₊ₓ(Zr_{y}+Ti_{1-y})O₃ (x=0*0.5, y=0.5-0.6), and said stress-reducing layer comprises a PZT film expressed by a formula: Pb₁₊ₓ(Zr_{y}+Ti_{1-y})O₃ (x=0*0.5, y=0.1-0.3).

9. An actuator comprising:
said piezo-electric film element of claim 1; and
a vibration plate formed adjacent to said piezo-electric film element.

10. An ink-jet head comprising:
a plurality of actuators, each of said actuators comprising said actuator of claim 9;
a plurality of pressure chambers corresponding to said plurality of actuators; and
a plurality of nozzles corresponding to said plurality of pressure chambers, said plurality of nozzles being operable to eject ink droplets.

11. An ink-jet recording apparatus comprising:
said ink-jet head of claim 10;
a controller for controlling said ink-jet head; and
an ink receiver for supplying ink to said ink-jet head.

12. A piezo-electric film element comprising:
a substrate;
a first electrode formed on said substrate;
a dielectric film formed on said first electrode; and
a second electrode formed on said dielectric thin film;
wherein said substrate comprises one of a first substrate having a heat expansion coefficient of 20˜40×10⁻⁷ (K⁻¹) and a second substrate having a heat expansion coefficient of 60˜150×10⁻⁷ (K⁻¹); and
wherein if said substrate comprises said first substrate, said dielectric film comprises a first dielectric film having a composition expressed by a formula: Pb₁₊ₓ(Zr_{y}+Ti_{1-y})O₃ (x=0-0.5, y=0.4-0.5), and if said substrate comprises said second substrate, said dielectric film comprises a second dielectric film having a composition expressed by a formula: Pb₁₊ₓ(Zr_{y}+Ti_{1-y})O₃ (x=0-0.5, 0.5<y≦0.7).

13. A piezo-electric film element comprising:
a substrate having a heat expansion coefficient;
a first electrode formed on said substrate;
a dielectric film formed on said first electrode, said dielectric film comprising a tetragonal structure of an oxide having a perovskite structure, and said dielectric film having heat expansion coefficient; and
a second electrode formed on said dielectric film;
wherein if said heat expansion coefficient of said dielectric film divided by said heat expansion coefficient of said substrate is in a range of 0.3 to 0.7, a c-axis oriented rate of said dielectric film is in a range of 10% to 40%, and if said heat expansion coefficient of said dielectric film divided by said heat expansion coefficient of said substrate is in a range of 1.0 to 2.5, a c-axis oriented rate of said dielectric film is in a range of 60% to 100%.

14. A piezo-electric film element comprising:
a substrate;
a first electrode formed on said substrate;
a dielectric film formed on said first electrode, said dielectric film having a composition expressed by a formula: Pb₁₊ₓ(Zr_{y}+Ti_{1-y})O₃ (x=0-0.5) and having a tetragonal structure; and
a second electrode formed on said dielectric film;
wherein said substrate comprises one of a first substrate having a heat expansion coefficient of 20˜40×10⁻⁷(K⁻¹) and a second substrate having a heat expansion coefficient of 60˜150×10⁻⁷ (K⁻¹); and
wherein if said substrate comprises said first substrate, said dielectric film comprises a first dielectric film having a composition expressed by a formula: Pb₁₊ₓ(Zr_{y}+Ti_{1-y})O₃ (x=0-0.5, y=0.4-0.5), and if said substrate comprises said second substrate, said dielectric film comprises a second dielectric film having a composition expressed by a formula: Pb₁₊ₓ(Zr_{y}+Ti_{1-y})O₃ (x=0-0.5, 0.5<y≦0.7).
